(19) United States
(12) Patent Application Publication
(10) Pub. No.: US 2008/0004059 A1
(43) Pub. Date: Jan. 3, 2008

(54) SYSTEM AND METHOD FOR PUSH TO TALK DIRECTION AND SERVICES

(76) Inventor: Hui Feng, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/427,006

(22) Filed: Jun. 28, 2006

(51) Int. Cl. H04B 7/00; H04Q 7/20

(52) U.S. Cl. 455/518

(57) ABSTRACT

Disclosed is a system, method and computer application for communication in a push to talk (PTT) and/or push to talk over cellular (PoC) that enables users to access additional services. The method generally includes requesting information (e.g., location information) associated with at least one portable communication device of a group of portable communication devices. Receiving the information and requesting additional services from a remote application server based on the received location information. Displaying the output of the service information in a user sensible format on a display associated with at least one of the portable communication devices.

### TECHNICAL FIELD OF THE INVENTION

The present invention relates to a method of communication between electronic equipment utilizing push-to-talk (PTT) and/or push-to talk over cellular (PoC) type communication protocols.

### DESCRIPTION OF THE RELATED ART

Push-to-talk (PTT) and Push-to-talk over cellular (PoC) type communications between electronic equipment are becoming increasingly popular with wireless communication customers. In general, PTT and PoC type systems are designed to provide an instant messenger service, similar to a walkie-talkie service. PTT and PoC type communications support instant group sessions. An instant group session enables a user of an inviting electronic equipment to establish a group session with a predefined group of electronic equipment. For example, a user may populate one or more user groups in advance by selecting and storing a list of electronic equipment for each user group in the memory of a PTT or PoC server in a wireless network. Each predefined user group generally has an associated group ID. To establish the instant group session, the inviting electronic equipment selects one of the predefined user groups and requests that the PTT or PoC server establish the group session with the selected user group. In response, the PTT or PoC server retrieves the selected user group from memory using the associated group ID, evaluates any access requirements, and sends an invite message to each portable communication device identified by the selected user group that satisfies any access requirements. The PTT or PoC server then establishes the group session between the inviting electronic equipment and any invited electronic equipment that accept the invitation.

The instant group session also enables a user of an inviting electronic equipment to establish a group chat with an ad hoc group of manually selected electronic equipment. The inviting electronic equipment provides the ad hoc group to the PTT or PoC server and requests that the server establish a group session with the selected electronic equipment. In response, the server sends an invite message to each electronic equipment identified in the ad hoc request that satisfies any access requirements. The PTT or PoC server then establishes the group session between the inviting electronic equipment and any invited electronic equipment that accept the invitation.

One drawback with conventional PTT and PoC type communications is that during a group session, additional services (e.g., presence, location, direction, directory, etc.) are typically unavailable during the same session. Another drawback with conventional PTT and PoC type communications is a lack of interactive services between group members.

### SUMMARY

In view of the aforementioned shortcomings associated with providing additional services during a group session in a PTT and/or PoC type communication system, there is a strong need in the art for a method and system to provide group member interaction and human client interaction with machine clients in the same group session.

One aspect of the present invention is directed to a method of communication, the method comprising: establishing a push to talk over cellular (PoC) group session with a plurality of portable communication devices; requesting information from a first server communicatively coupled to one or more of the portable communication devices, wherein the information relates to location information associated with one or more of the portable communication devices; receiving location information associated with one or more of the portable communication devices; and requesting a service from a second server based at least in part on the received information.

According to an aspect of the invention the received information is displayed in a user sensible format on a display of one more of the portable communication devices.

According to an aspect of the invention, the service is a directory service, information service, driving direction service and/or Internet service.

According to an aspect of the invention, the first server is a presence server.

According to an aspect of the invention, wherein the second server is an Internet server.

According to an aspect of the invention, the location information associated with at least one of the portable communication devices is periodically updated.

According to an aspect of the invention, the location information associated with at least one of the portable communication devices is interactively updated based on a request from an associated user of at least one of the portable communication devices.

Another aspect of the invention relates to a communication method comprising: requesting location information associated with at least one portable communication device of a group of portable communication devices; receiving the location information associated with the at least one portable communication device; requesting additional services from a remote application server based on the received location information; receiving service information related to the location information based upon processing of the remote application server; and displaying the service information is a user sensible format on a display associated with at least one of the portable communication devices.

According to an aspect of the invention, the service is a directory service, information service, driving direction service and/or Internet service.

According to an aspect of the invention, the location information is transmitted by a presence server to the at least one portable communication device.

According to an aspect of the invention, the remote application server is an Internet server.

According to an aspect of the invention, the location information associated with at least one of the portable communication devices is periodically updated.

According to an aspect of the invention, the location information associated with at least one of the portable communication devices is interactively updated based on a request from an associated user of at least one of the portable communication devices.

Another aspect of the invention relates to a method of determining a location of a portable communication device in a push to talk over cellular (PoC) group session, the portable communication device having a plurality of remote portable communication devices associated therewith, said method comprising: initiating a query at a first portable communication device as to the location presently associated with at least of the remote portable communication devices of the PoC group; and responding to the query at a remote server associated with at least one of the remote portable communication devices by transmitting location information presently associated with the remote member; and displaying the location information on a display of the first portable communication device.

According to an aspect of the invention location information associated with the first portable communication device and at least one other remote portable communication device is displayed.

According to an aspect of the invention, at least one regional attraction, restaurant and/or hotel is displayed on the display.

According to an aspect of the invention, a driving direction service for driving directions between the first portable communication device and at least one remote portable communication device from a remote application server is provided.

According to an aspect of the invention, driving directions between the first portable communication device and the at least one remote portable communication device are displayed.

According to an aspect of the invention, periodically and/or interactively updating location position information related to the first portable communication device and the at least one remote terminal and displaying the updated position information.

Another aspect of the invention relates to a computer program stored on a machine readable medium, the program being suitable for use in an electronic equipment having a push to talk over cellular application, wherein when the electronic equipment initiates a query as to the location presently associated with at least one a of remote electronic equipment in a push to talk over cellular group session, the electronic equipment receives a response from a remote server associated with at least one of the remote electronic equipment, wherein the response includes location information presently associated with the remote electronic equipment and the electronic equipment displays the location information on an associated display.

According to an aspect of the invention, periodically and/or interactively updating location position information related to the electronic equipment and the at least one remote electronic equipment and displaying information related at least in part to the location information.

According to an aspect of the invention, at least one regional attraction, restaurant and/or hotel is displayed on the associated display.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary illustration of a communication system in accordance with aspects of the present invention.

FIG. 2 is a schematic diagram illustrating electronic equipment in accordance with aspects of the present invention.

FIG. 3 is an exemplary illustration of a communication system in accordance with aspects of the present invention.

FIGS. 4, 5 and 6 are exemplary methods in accordance with aspects of the present invention.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Aspects of the invention include electronic equipment and a method and system of exchanging information between group members in a PTT and/or PoC group session to provide additional services to the group members. In one aspect, a method of communication is disclosed. The method includes establishing a push to talk over cellular (PoC) group session with a plurality of portable communication devices; requesting information from a first server communicatively coupled to one or more of the portable communication devices, wherein the information relates to location information associated with one or more of the portable communication devices; receiving location information associated with one or more of the portable communication devices; and requesting a service from a second server based at least in part on the received information.

In another embodiment, a communication method is disclosed. The method includes requesting location information associated with at least one portable communication device of a group of portable communication devices; receiving the location information associated with the at least one portable communication device; requesting additional services from a remote application server based on the received location information; receiving service information related to the location information based upon processing of the remote application server; and displaying the service information is a user sensible format on a display associated with at least one of the portable communication devices.

In another embodiment, a method of determining a location of a portable communication device in a push to talk over cellular (PoC) group session is disclosed. The method includes initiating a query at a first portable communication device as to the location presently associated with at least of the remote portable communication devices of the PoC group; and responding to the query at a remote server associated with at least one of the remote portable communication devices by transmitting location information presently associated with the remote member; and displaying the location information on a display of the first portable communication device.

As used herein, the term “electronic equipment” includes portable radio communication equipment. The term “portable radio communication equipment”, which herein after may be referred to as a mobile phone, a mobile device, a portable communication device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used in connection with PTT and/or PoC type communications.

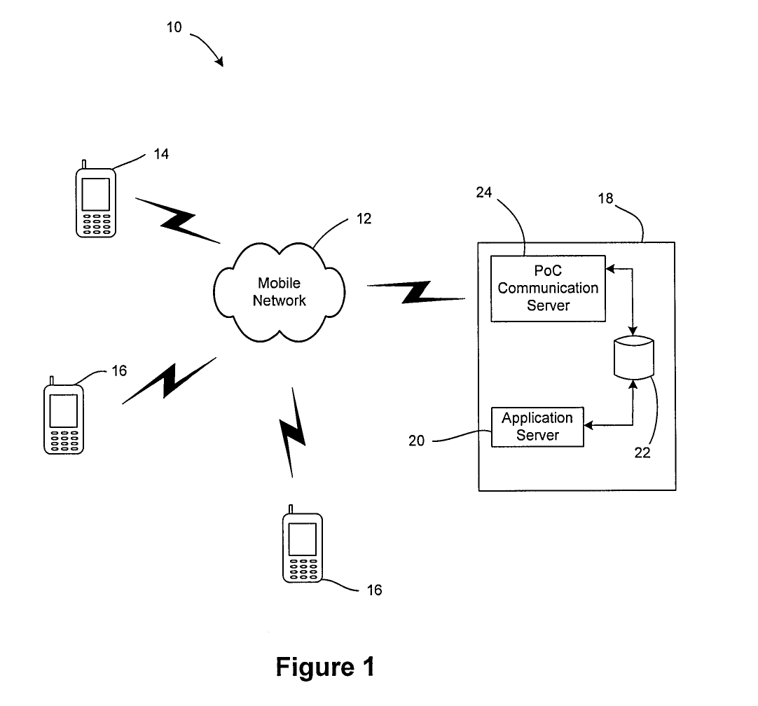

Referring initially to FIG. 1, an exemplary communication system 10 is illustrated. The communication system 10 includes a mobile network 12, such as a mobile cellular telephony network, that facilitates communication, such as voice communication and/or data transfer between a plurality of portable communication devices 14 and 16, such as mobile terminals, mobile phones, electronic equipment, servers or the like. The communication system 10 and at least two of the portable communication devices 14, 16 support PTT and/or PoC communications, e.g., by including a PTT and/or PoC application program. For purposes of the discussion contained herein, portable communication device 14 will be described in terms of inviting, initiating and/or activating a PoC group session with portable communication devices 16. However, it will be appreciated that the method described more fully below can be carried out by any suitably equipped portable communication device, regardless of whether that device initiates a PoC session or responds to an invitation to participate in a PTT session. In addition, while the invention is described with respect to PoC, the invention is also directed to all other push-to-talk communication protocols (e.g., PTT and the like).

The communication system 10 includes a network infrastructure 18, portions of which are used or otherwise accessed by the portable communication devices in connection with aspects of the invention. The portable communication devices 14, 16 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Voice-Over IP (VoIP), Session Initiated Protocol (SIP), Wireless Local Area Network (WLAN) or the like. In other words, the communication system is shown in FIG. 1 for purposes of explaining aspects of the present invention, without limiting the invention to a particular communication system design, architecture or communication standard.

The network infrastructure 18 includes one or more application servers, which are indicated generally by the numeral 20, and a storage device 22, such as a memory for storing data accessible or otherwise usable by the application servers 18. At least one of the application servers is a push-to-talk over cellular (PoC) communication server 24. The application servers 18, including the PoC communication server 24, are computer servers that serve different functions in the communication system. The application servers 18 may support any type of application. Exemplary applications may include location, presence, global positioning, Internet, directory, short message service, electronic mail and the like. As is described more fully below, the portable communication devices 14 and 16 utilize information received during a PoC group session for execution of application programs stored internally and/or stored remotely on a remote server (e.g., application severs 18).

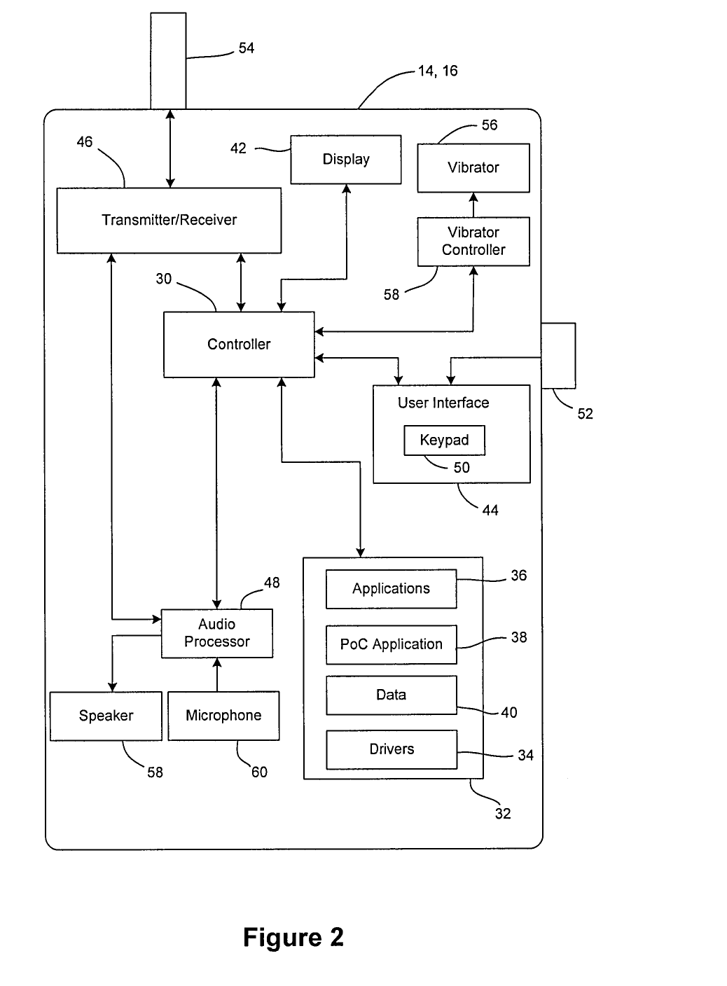

FIG. 2 represents a functional block diagram of a portable communication device 14 and 16 in accordance with aspects of the present invention. The portable communication devices 14 and 16 include a controller 30 for controlling the overall operation of the portable communication device. The controller 30 may be any commercially available or custom microprocessor. Memory 32 is operatively connected to the controller 30 for storing control programs and data used by the portable communication device. The memory 32 is representative of the overall hierarchy of memory devices containing software and data used to implement the functionality of the portable communication device in accordance with aspects of the present invention.

In the illustrated embodiment, memory 32 stores device drivers 34, e.g., I/O device drivers, application programs, indicated generally by reference numeral 36 generally, including a PoC application program 38 (also referred to as a PoC processor) and application program data 40 that supports the functionality described more fully herein. The I/O device drivers include software routines that are accessed through the controller 30 (or by an operating system (not shown) stored in memory 32) by the application programs 36, including the PoC application program 38, to communicate with devices such as the display 42 and other input/output ports.

The application programs 36, including the PoC application program 38, comprise programs that implement various features of the portable communication device 14, 16, such as e-mail, Internet access, contact manager, mapping and the like. As is discussed more fully below, the PoC application program 38 comprises a program that facilitates PoC communications. In addition, the PoC application program 38 and one or more of the application programs 36 may work in conjunction to exchange information (e.g. PoC group session information) to facilitate the functionality described herein and also to provide a graphical user interface to display information in a user friendly manner.

A person having ordinary skill in the art of computer programming, and specifically in applications programming for portable communication devices will consider it obvious in view of the description provided herein to program a mobile phone to operate and carry out the functions described herein with respect to the PoC application program 38 and other application programs 36 (and any interfacing between the PoC application program 38 and other application programs 36 present on the mobile phone). Accordingly, details as to specific programming code have been left out for the sake of brevity. Also, while the PoC communication functionality, including displaying location information and/or user information associated with members of PoC group session is generally carried out via the processor and PoC application program 38 (alone or in conjunction with other application programs and control modules) in memory 32 in accordance with aspects of the invention, such function could also be carried out via dedicated hardware, firmware, software or combinations thereof without departing from the scope of the present invention.

With continued reference to FIG. 2, the controller 30 interfaces with the display 42, a user interface unit 44, a transmitter/receiver 46 (often referred to as a transceiver) and audio processing circuits, such as an audio processor 48, e.g., an audio processing circuit. In the illustrated embodiment, the user interface unit 44 includes or is operatively coupled to a keypad 50 and a PoC actuator 52, e.g., a button used to initiate PoC functions, such as initiating a PoC communication session, taking control of the floor and the like, during a typical PoC communication session. While the PoC actuator 52 is depicted as a separate and dedicated user interface button, it will be appreciated that other existing buttons or keys on the mobile phone, e.g., one or more of the keys within the keypad 50 (so-called “soft keys), may be employed to provide the PoC functionality. In other words, the present invention is not intended to be limited to any particular configuration or geometry of PoC actuators.

The display 42, keypad 50 and the PoC actuator 52 are part of a user interface unit 44 that allows the user to interact with the mobile phone 14, 16. For example, keypad 50 allows the user to dial numbers, enter commands and data, and select options. The display 42 allows the user to view a variety of information, such as dialed digits, stored information, and output from various applications, including the PoC application program 38. As is discussed more fully below, the PoC actuator 52 allows a user to initiate a PoC session, e.g., inviting one or more other users to participate in a PoC communications session, and/or take control of the floor for speaking during the PoC communications session, in response to or otherwise based on signals provided by the mobile phone.

An antenna 54 is coupled to the transmitter/receiver 46 such that the transmitter/receiver 46 transmits and receives signals via the antenna 54, as is conventional. The portable communication device 14, 16 includes an audio processor 48 for processing the audio signal transmitted by and received from the transmitter/receiver 46. Coupled to the audio processor 48 are a speaker 58 and microphone 60, which enable a user to listen and speak via the portable communication device.

While for purposes of simplicity of explanation, the methods illustrated herein include a series of steps or functional blocks that represent one or more aspects of the relevant operation of the portable communication device 14, 16, it is to be understood and appreciated that aspects of the present invention are not limited to the order of steps or functional blocks, as some steps or functional blocks may, in accordance with aspects of the present invention, occur in different orders and/or concurrently with other steps or functional blocks from that shown and described herein. Moreover, not all illustrated steps or functional blocks of aspects of relevant operation may be required to implement a methodology in accordance with an aspect of the invention. Furthermore, additional steps or functional blocks of aspects of relevant operation may be added without departing from the scope of the present invention.

One of ordinary skill in the art will appreciate that, in general, the signal flow associated with a PoC communication session includes one user attempting to activate or otherwise initiate a PoC communication session by transmitting an activation request, e.g., by pressing the appropriate actuator or PoC call button. An appropriate server, e.g., a PoC communication server verifies that a PoC communication channel is available, and then assigns a channel to the requesting mobile phone. Any message provided by the user of the requesting mobile phone is received by the PoC communication server and relayed to each receiving or invited mobile phone. Once a PoC communication session is established between at least two mobile phones, only one party at a time may speak or otherwise transmit data. Typically, this is accomplished by the user pressing and holding the PoC actuator on the mobile phone (also referred to as taking control of the floor). Typically, floor control is granted or otherwise established by the controlling PoC communication server. A user may continue to speak while the user has control of the floor. When the user is finished speaking, the user may release the PoC actuator, thereby relinquishing control of the floor so that another participant in the PoC communication session may speak after taking control of the floor.

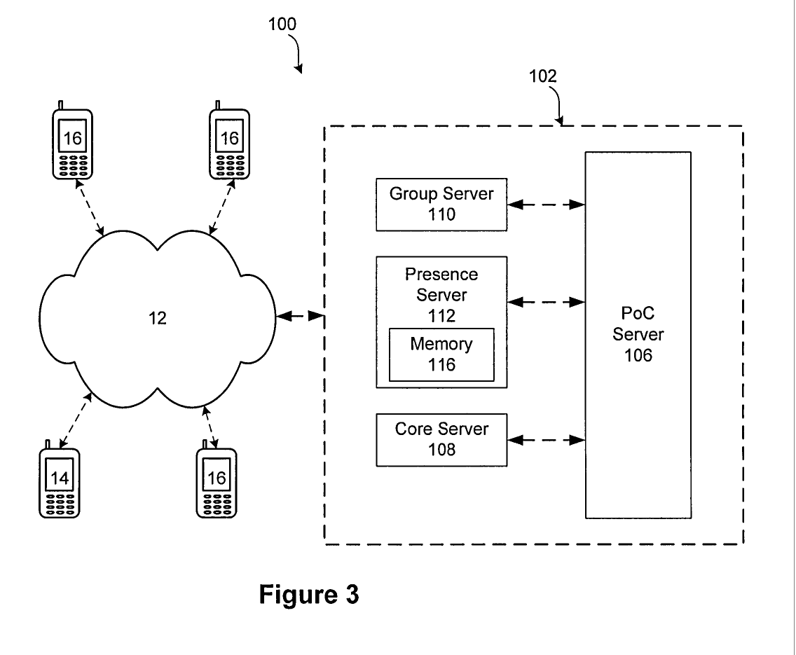

FIG. 3 illustrates an exemplary PoC system 100 according to aspects of the present invention. PoC system 100 includes a PoC controller 102, identified by the dotted lines, and one or more portable communication devices 104. The PoC controller 102 includes a PoC server 106, a core server 108, a group server 110, a presence server 112, and application server 114. Core server 108 is typically an Internet Protocol (IP) Multimedia Subsystem (IMS) server that is responsible for, among other things, routing the Session Initiation Protocol (SIP) signaling between the portable communication devices 104, the PoC server 106 and the applicable application servers (e.g., presence server 112, application server 114, etc.). In particular, core server 108 receives requests for specified group sessions from an inviting portable communication device (identified by reference 14) and forwards these requests, along with a selected list of potential group members, to the PoC server 106.

Group server 110, also known as the Group and List Management Server (GLMS), is responsible for managing the various PoC groups, contact lists, and access lists associated with the portable communication devices 104 (e.g., portable communication devices 14 and 16). Each PoC group generally comprises a collection of PoC user identities defined by a potential inviting portable communication device 14, as discussed above. Contact list management, as performed by group server 110, includes operations that allow a portable communication device 14 and 16 to store and retrieve the contact list(s) stored in group server 110.

According to the present invention, the group server 110 and the core server 108 exchange information directly. Likewise, the group server 110 and the core server 108 also exchange information with the presence server 112 and/or the application server 114 as needed to produce the functionality described herein. The presence server 112 manages presence and location information corresponding to portable communication devices 104 with PoC capabilities. In other words, the presence server 112 monitors the availability and location of all portable communication devices 104 with PoC capabilities associated with the group session. In some embodiments, the presence server 112 may also include a memory 116 for storing presence and location information related to portable communication devices 104 with PoC capabilities. In addition, the presence server 112 may keep dynamic lists of portable communication devices 104 currently located in selected areas. It will be appreciated by those skilled in the art that the presence and location information may be obtained by the PoC controller 102 according to any means known in the art.

Once the location information is obtained from the presence server 112, the location information may be shared with one or more of the portable communication devices 104 and/or application server 114. For example, a user of portable communication devices 14 and/or 16 may request information about one or more members of the PoC group session. The location information may be transmitted to the requesting portable communication device (e.g. portable communication device 14). The portable communication device may utilize an application program 36 to obtain additional information and/or services related to the location information. For example, in one embodiment, the inviting portable communication device 14 may seek location information related to one or more of the portable communication devices 104. An application program stored on the portable communication device 14 may display a map to the user with one or more of the portable communication devices 104 displayed therein. Another application program 36 may acquire direction information, find a restaurant, find a local attraction and/or any other service that may be based upon location of one or more of the portable communication devices 104. Generally, the acquisition of information is provided from on or more remote application servers 114.

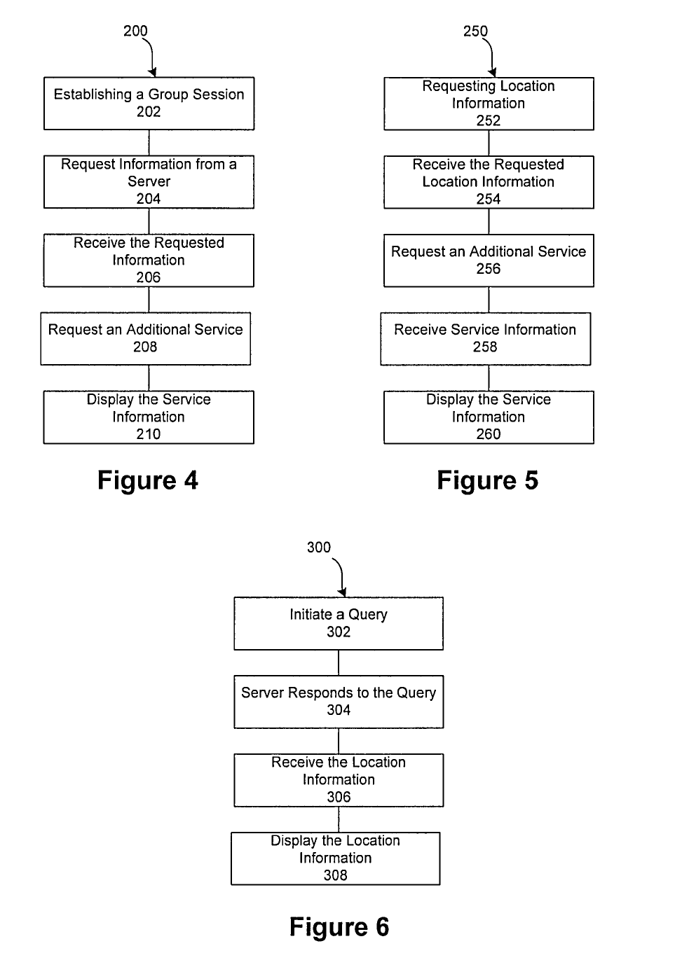

Referring to FIG. 4, an exemplary method 200 in accordance with the present invention is illustrated. The method 200 includes at step 202 establishing a push to talk over cellular (PoC) group session with a plurality of portable communication devices. The establishment of the PoC may be accomplished in any conventional manner.

At step 204, the portable communication device requests information from a first server communicatively coupled to one or more of the portable communication devices, wherein the information relates to location information associated with one or more of the portable communication devices. The requested information may be any desirable information associated with the portable communication device. For example, the information may be location information, contact information and the like. The first server may be a presence server, a global positioning server or any other server capable of providing the requested information. At step 206, the requested information associated with one or more of the portable communication devices is received at the requesting portable communication device. Generally, the portable communication devices exchange information by use of the PoC controller 102.

At step 208, the portable communication device that requested the information may further request a service from a second server based at least in part on the received information. For example, once the requesting portable communication device receives the requested information during the PoC group session, the portable communication device may then request additional services. For example, the requesting portable communication device may transmit the received information to an application server to receive driving directions, location information, attraction information, hotel information, restaurant information, directory services, Internet services, E-mail services, SMS services and the like based on the information received. The second server may be any suitable server. For example, the second server may be one or more application servers. While the first server and the second server have been referenced as remote from each other, one of ordinary skill in the art will readily appreciate that the first server and the second server may physically be a single server having a least a portion of the data discreetly stored. An exemplary second server may include, for example, an Internet server, a presence server, etc. At step 210, the received information is displayed in a user sensible format on a display of one more of the portable communication devices.

Preferably, the information exchanged between may be updated. The information exchanged may be updated periodically at a predetermined time and/or a predetermined event. In addition, the information exchanged may be interactively updated by one or more of the associated users of the portable communication devices.

Referring to FIG. 5 another exemplary method 250 in accordance with the present invention is disclosed. The method 250 includes at step 252, requesting location information associated with at least one portable communication device of a group of portable communication devices. The request may originate from any portable communication device involved in a PoC group session. The location information may be any location information associated with one or more of the portable communication devices. For example, location information may include global positioning coordinates or any other mechanism to identify the geographical location of any portable communication device in the PoC group session. At step 254, the location information associated with the at least one portable communication device is received at the requesting portable communication device. At step 256, the requesting portable communication device may request additional services from a remote application server based on the received location information. For example, once the requesting portable communication device receives the requested information during the PoC group session, the portable communication device may then request additional services. For example, the requesting portable communication device may transmit the information to an application server to receive driving directions, location information, attraction information, hotel information, restaurant information, directory services, Internet services, E-mail services, SMS services, etc. based on the information received. At step 258, the requesting portable communication device receives service information related to the location information based upon processing of the location information at the remote application server. At step 260, the service information is displayed in a user sensible format on a display associated with at least one of the portable communication devices.

Preferably, the information exchanged between the portable communication devices may be updated. The information exchanged may be updated periodically at a predetermined time and/or a predetermined event. In addition, the information exchanged may be interactively updated by one or more of the associated users of the portable communication devices.

Another exemplary method 300 is illustrated in FIG. 6. The method 300 relates to a method of determining a location of a portable communication device in a PoC group session. At step 302, a query is initiated at a first portable communication device as to the location presently associated with at least of the remote portable communication devices of the PoC group. At step 304, the query is responded to at a remote server associated with at least one of the remote portable communication devices by transmitting location information presently associated with the remote member. The remote server may be any server capable of providing the functionality described herein. For example, the remote server may be a presence server, an application server, a global positioning server, etc. At step 306, the location information is received from the remote server. At step 308, the location information is displayed on a display of the first portable communication device. In one embodiment, the location information associated with the first portable communication device and at least one other remote portable communication device are displayed together on the display in order to illustrate the relative positions of the portable communication devices. In another embodiment, a driving direction service for driving directions between the first portable communication device and at least one remote portable communication device from a remote application server is requested and displayed.

Preferably, when the portable communication devices are displayed on the display, the displaying portable communication device includes application software that will generate a map or be capable of receiving map information from a remote source. It is also preferable that local and/or regional attractions are displayed. Such attractions my include points of interests, monuments, museums, parks and like. In addition other information may also be displayed such as restaurants, hotels, gas stations and the like.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method of communication, the method comprising:
establishing a push to talk over cellular (PoC) group session with a plurality of portable communication devices;
requesting information from a first server communicatively coupled to one or more of the portable communication devices, wherein the information relates to location information associated with one or more of the portable communication devices;
receiving location information associated with one or more of the portable communication devices;
requesting a service from a second server based at least in part on the received information.

2. The method of claim 1 further including displaying the received information in a user sensible format on a display of one more of the portable communication devices.

3. The method of claim 1, wherein the service is a directory service, information service, driving direction service and/or Internet service.

4. The method of claim 1, wherein the first server is a presence server.

5. The method of claim 1, wherein the second server is an Internet server.

6. The method of claim 1, wherein the location information associated with at least one of the portable communication devices is periodically updated.

7. The method of claim 1, wherein the location information associated with at least one of the portable communication devices is interactively updated based on a request from an associated user of at least one of the portable communication devices.

8. A communication method comprising:
requesting location information associated with at least one portable communication device of a group of portable communication devices,
receiving the location information associated with the at least one portable communication device; and
requesting additional services from a remote application server based on the received location information;
receiving service information related to the location information based upon processing of the remote application server;
displaying the service information is a user sensible format on a display associated with at least one of the portable communication devices.

9. The method of claim 8, wherein the service is a directory service, information service, driving direction service and/or Internet service.

10. The method of claim 8, wherein the location information is transmitted by a presence server to the at least one portable communication device.

11. The method of claim 8, wherein the remote application server is an Internet server.

12. The method of claim 8, wherein the location information associated with at least one of the portable communication devices is periodically updated.

13. The method of claim 8, wherein the location information associated with at least one of the portable communication devices is interactively updated based on a request from an associated user of at least one of the portable communication devices.

14. A method of determining a location of a portable communication device in a push to talk over cellular (PoC) group session, the portable communication device having a plurality of remote portable communication devices associated therewith, said method comprising: initiating a query at a first portable communication device as to the location presently associated with at least of the remote portable communication devices of the PoC group; and responding to the query at a remote server associated with at least one of the remote portable communication devices by transmitting location information presently associated with the remote member; and displaying the location information on a display of the first portable communication device.

15. The method of claim 14 further including displaying location information associated with the first portable communication device and at least one other remote portable communication device.

16. The method of claim 15 further including displaying at least one regional attraction, restaurant and/or hotel on the display.

17. The method of claim 14 further including providing a driving direction service for driving directions between the first portable communication device and at least one remote portable communication device from a remote application server.

18. The method of claim 17 further including displaying driving directions between the first portable communication device and the at least one remote portable communication device.

19. The method of claim 16 further including periodically and/or interactively updating location position information related to the first portable communication device and the at least one remote terminal and displaying the updated position information.

20. A computer program stored on a machine readable medium, the program being suitable for use in an electronic equipment having a push to talk over cellular application, wherein when the electronic equipment initiates a query as to the location presently associated with at least one a of remote electronic equipment in a push to talk over cellular group session, the electronic equipment receives a response from a remote server associated with at least one of the remote electronic equipment, wherein the response includes location information presently associated with the remote electronic equipment and the electronic equipment displays the location information on an associated display.

21. The computer program of claim 20 further including periodically and/or interactively updating location position information related to the electronic equipment and the at least one remote electronic equipment and displaying information related at least in part to the location information.

22. The computer program of claim 21 further including displaying at least one regional attraction, restaurant and/or hotel on the associated display.
